(19) United States
(12) Patent Application Publication
(10) Pub. No.: US 2026/0051309 A1
(43) Pub. Date: Feb. 19, 2026

(54) SYSTEMS AND METHODS FOR PASSIVELY MANAGING ENVIRONMENTAL NOISE

(71) Applicant: Saudi Arabian Oil Company, Dhahran (SA)

(72) Inventors: Ali J. Alrasheed, Thuwal (SA); Sahejad Patel, Thuwal (SA); Amjad Felemban, Thuwal (SA); Fadl Abdellatif, Thuwal (SA); Ibrahim S. Alsalamah, Thuwal (SA)

(21) Appl. No.: 18/808,605

(22) Filed: Aug. 19, 2024

(51) Int. Cl. G10K 11/16; G01M 3/28

(52) U.S. Cl. CPC G10K 11/161; G01M 3/2876

(57) ABSTRACT

A passive noise management system includes a housing that includes a volume defined by an outer surface and an inner surface; and an opening in the housing configured to access the volume. The volume is configured to at least partially enclose an acoustic device configured to measure acoustic energy generated by an object. The housing is configured to couple to the object to form an enclosure around the acoustic device that is fluidly decoupled from an ambient environment. The enclosure includes the housing and at least a portion of the object. The passive noise management system includes at least one sound reducer coupled to the housing or enclosed within the volume. The at least one sound reducer is configured to reduce an amount of environmental noise transferred from the ambient environment, through the housing, and to the acoustic device.

### TECHNICAL FIELD

This disclosure relates to systems and methods for passively managing environmental noise and, more particularly, systems and methods for passive noise isolation, cancellation, or both, of environmental noise that surrounds an acoustic sensing device.

### BACKGROUND

Acoustic devices used to sense physical phenomena often encounter significant difficulties due to the presence of surrounding environmental noise. This noise can distort the detected signals leading to inaccurate measurements and compromised performance, which affects final reporting and decision making regarding the integrity status of the object being inspected or maintained (for example, a leaking valve that needs replacement).

### SUMMARY

In an example implementation, a passive noise management system includes a housing that includes a volume defined by an outer surface and an inner surface; and an opening in the housing configured to access the volume. The volume is configured to at least partially enclose an acoustic device configured to measure acoustic energy generated by an object. The housing is configured to couple to the object to form an enclosure around the acoustic device that is fluidly decoupled from an ambient environment. The enclosure includes the housing and at least a portion of the object. The passive noise management system includes at least one sound reducer coupled to the housing or enclosed within the volume. The at least one sound reducer is configured to reduce an amount of environmental noise transferred from the ambient environment, through the housing, and to the acoustic device.

In an aspect combinable with the example implementation, the at least one sound reducer includes an insulation enclosed within the volume.

In another aspect combinable with one, some, or all of the previous aspects, the at least one sound reducer includes a sound reduction coating or sound reduction layer coupled to at least one of the outer surface or the inner surface.

In another aspect combinable with one, some, or all of the previous aspects, the at least one sound reducer includes a sound reduction coating or sound reduction layer coupled to the outer surface and the inner surface.

In another aspect combinable with one, some, or all of the previous aspects, the sound reduction coating or sound reduction layer includes an anechoic coating or layer.

In another aspect combinable with one, some, or all of the previous aspects, the sound reduction coating or sound reduction layer includes at least one of a SonoPan layer, a drywall layer, an MDF layer, or a plywood layer.

In another aspect combinable with one, some, or all of the previous aspects, the housing is a first housing, and the system includes a second housing that includes a second volume defined by a second outer surface and a second inner surface; and a second opening in the second housing configured to access the first housing and the acoustic device.

In another aspect combinable with one, some, or all of the previous aspects, the second volume is configured to at least partially enclose the first housing.

In another aspect combinable with one, some, or all of the previous aspects, the second housing is configured to couple to the object to form a second enclosure around the first acoustic device that is fluidly decoupled from the ambient environment.

In another aspect combinable with one, some, or all of the previous aspects, the second enclosure includes the second housing and at least another portion of the object.

In another aspect combinable with one, some, or all of the previous aspects, the acoustic device is attached to the inner surface with a biasing member configured to urge the acoustic device into contact with the object.

Another aspect combinable with one, some, or all of the previous aspects includes one or more magnets configured to detachably secure the housing to the object.

Another aspect combinable with one, some, or all of the previous aspects includes a port positioned on the housing and configured, when open, to fluidly couple the volume to the ambient environment and further configured, when closed, to fluidly isolate the volume from the ambient environment.

In another aspect combinable with one, some, or all of the previous aspects, the at least one sound reducer includes a fluid circulated into the volume through the port when opened.

In another aspect combinable with one, some, or all of the previous aspects, the at least one sound reducer includes a vacuum pulled in the volume by exhausting at least a portion of air from the volume to the ambient environment through the port when opened.

Another aspect combinable with one, some, or all of the previous aspects includes a control circuit positioned in the volume, the control circuit configured to output a noise signal that cancels at least a portion of the environmental noise.

In another aspect combinable with one, some, or all of the previous aspects, the control circuit executes a machine learning or artificial intelligence model to output the noise signal that cancels the portion of the environmental noise.

In another aspect combinable with one, some, or all of the previous aspects, the object includes a pipeline.

In another example implementation, a method includes positioning an acoustic device in a housing of a passive noise management system; and coupling the housing to an object to form an enclosure around the acoustic device that is fluidly decoupled from an ambient environment. The housing includes a volume defined by an outer surface and an inner surface; and an opening in the housing configured to access the volume, the volume configured to at least partially enclose. The method includes, subsequent to coupling the housing to the object, measuring acoustic energy generated by the object with the acoustic device; and during measuring, reducing an amount of environmental noise transferred from the ambient environment, through the housing, and to the acoustic device with at least one sound reducer coupled to the housing or enclosed within the volume.

An aspect combinable with the example implementation includes reducing the amount of environmental noise transferred from the ambient environment, through the housing, and to the acoustic device with the at least one sound reducer that includes an insulation enclosed within the volume.

Another aspect combinable with one, some, or all of the previous aspects includes reducing the amount of environmental noise transferred from the ambient environment, through the housing, and to the acoustic device with the at least one sound reducer that includes a sound reduction coating or sound reduction layer coupled to at least one of the outer surface or the inner surface.

Another aspect combinable with one, some, or all of the previous aspects includes reducing the amount of environmental noise transferred from the ambient environment, through the housing, and to the acoustic device with the at least one sound reducer that includes a sound reduction coating or sound reduction layer coupled to the outer surface and the inner surface.

In another aspect combinable with one, some, or all of the previous aspects, the sound reduction coating or sound reduction layer includes an anechoic coating or layer.

In another aspect combinable with one, some, or all of the previous aspects, the sound reduction coating or sound reduction layer includes at least one of a SonoPan layer, a drywall layer, an MDF layer, or a plywood layer.

In another aspect combinable with one, some, or all of the previous aspects, the housing is a first housing, and the method includes at least partially enclosing the first housing in a second housing of the passive noise management system. The second housing includes a second volume defined by a second outer surface and a second inner surface; and a second opening in the second housing configured to access the first housing and the acoustic device. The second volume is configured to at least partially enclose the first housing, the second housing configured to couple to the object to form a second enclosure around the first acoustic device that is fluidly decoupled from the ambient environment. The second enclosure includes the second housing and at least another portion of the object.

Another aspect combinable with one, some, or all of the previous aspects includes urging the acoustic device into contact with the object with a biasing member that attaches the acoustic device to the inner surface.

In another aspect combinable with one, some, or all of the previous aspects, coupling the housing to the object includes detachably securing the housing to the object with one or more magnets.

Another aspect combinable with one, some, or all of the previous aspects includes operating a port positioned on the housing to open the port to fluidly couple the volume to the ambient environment; or close the port to fluidly isolate the volume from the ambient environment.

Another aspect combinable with one, some, or all of the previous aspects includes operating the port to open the port; circulating a fluid through the opened port into the volume; operating the port to close the port to enclose the circulated fluid in the volume; and reducing the amount of environmental noise transferred from the ambient environment, through the housing, and to the acoustic device with the fluid in the volume.

Another aspect combinable with one, some, or all of the previous aspects includes operating the port to open the port; circulating a fluid through the opened port from the volume into the ambient environment; operating the port to close the port to create at least a partial vacuum in the volume; and reducing the amount of environmental noise transferred from the ambient environment, through the housing, and to the acoustic device with the at least partial vacuum.

Another aspect combinable with one, some, or all of the previous aspects includes generating, with a control circuit a noise signal; and canceling at least a portion of the environmental noise with the generated noise signal.

Another aspect combinable with one, some, or all of the previous aspects includes executing, with the control circuit, a machine learning or artificial intelligence model to generate the noise signal.

In another aspect combinable with one, some, or all of the previous aspects, the object includes a pipeline.

Implementations of passive noise isolation and cancellation systems and methods according to the present disclosure may include one or more of the following features. For example, implementations according to the present disclosure can increase an accuracy of detection of a target phenomena, such as noise generated by a valve or fluid flow or other target phenomena, by reducing external noise effects. As another example, implementations according to the present disclosure can passively reduce noise without requiring any energy expenditure, making it economically attractive.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic diagram of an example implementation of a passive noise management system according to the present disclosure.

FIG. 2 is a schematic diagram of another example implementation of a passive noise management system according to the present disclosure.

FIGS. 3A and 3B are schematic diagrams of another example implementation of a passive noise management system according to the present disclosure.

FIG. 4 is a schematic diagram of another example implementation of a passive noise management system according to the present disclosure.

FIGS. 5A and 5B are schematic diagrams of another example implementation of a passive noise management system according to the present disclosure.

FIGS. 6A-6C are schematic diagrams of example sound reduction or cancellation coatings for an example implementation of a passive noise management system according to the present disclosure.

FIG. 7 is a schematic diagram of an example process for using a machine learning or an artificial intelligence model with a passive noise management system to reduce noise in an audio signal according to the present disclosure.

FIG. 8 is a schematic illustration of an example controller (or control system) for a passive noise management system according to the present disclosure.

### DETAILED DESCRIPTION

The present disclosure describes example implementations of a passive noise management system that includes one or more passive noise enclosures operable to isolate (completely or partially) an acoustic sensing device from environmental noise as it detects or measures specific process sounds or noise (with which the environmental noise would otherwise interfere). Generally, a passive noise enclosure according to the present disclosure can introduce passive noise isolation and canceling techniques for acoustic devices and can be specifically designed to reduce an impact of surrounding noise. In some aspects, a passive noise enclosure according to the present disclosure can integrate high-frequency materials for absorption and low-frequency damping materials so as to more effectively attenuate environmental noise across a wide range of frequencies. In some aspects, a passive noise enclosure according to the present disclosure can utilize a vacuum or introduce a noise absorbing fluid to surround the acoustic device to further attenuate environmental noise. In some aspects, a passive noise enclosure according to the present disclosure can include a machine learning or AI-based approach to noise attenuation or canceling by utilizing deep learning algorithms for adaptive noise cancelation. These algorithms can learn to model and predict the characteristics of noise by generating anti-noise signals that cancel out unwanted noise components. In some aspects, a combination of passive noise reduction techniques and AI-based noise cancelation can enhance a performance of acoustic devices, enabling accurate and reliable measurements even in noisy environments.

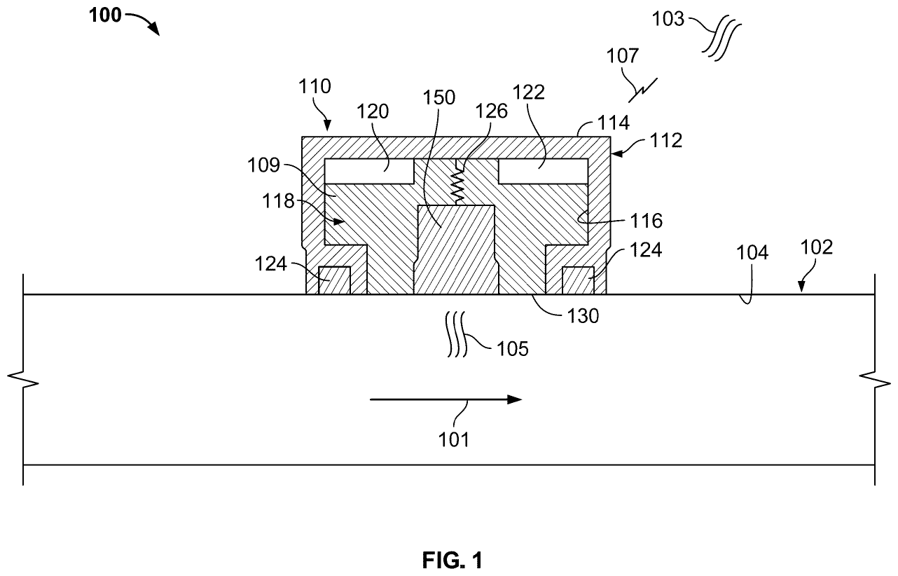

FIG. 1 is a schematic diagram of an example implementation of a passive noise management system 100 according to the present disclosure. The example passive noise management system 100, as shown, includes a passive noise enclosure 110 that is coupled to (in other words, detachably engaged with) a pipeline 102 that carries a fluid 101 therethrough. In this example, the fluid 101 represents a noise source that is desired to be measured or monitored, as the fluid 101 creates noise 105 during circulation (or otherwise). However, other noise sources, such as valves or other mechanical devices are also contemplated by the present disclosure.

As shown in this example, an acoustic device 150 is mounted to (attached or otherwise in contact with) a wall 104 of the pipeline 102 and operable to measure the noise 105. In this particular example of the passive noise management system 100, the pipeline 102 can be some or all of a flare gas pipeline in a hydrocarbon fluid system. For example, noise 105 may be monitored in such a system, as an unintentional passing of gases to a flare system in oil and gas plants is a common issue that can result in significant business losses and environmental impacts. In these plants, gases that are produced during the oil and gas production processes are often burned off in a flare system to reduce the amount of gas that is released into the atmosphere. However, when the gases are not meant to be burned can result in a significant loss of valuable resources. In addition to business losses, unintentional passing of gases to the flare system can also be detrimental to the environment. The gases that escape into the atmosphere can contribute to air pollution and may also contribute to the greenhouse effect and global warming, as they trap heat in the atmosphere and contribute to the warming of the planet.

To minimize the risk of unintended gas releases, noise 105 can be measured or monitored to detect the unintentional passing, which prevents the loss valuable hydro-carbon as well as minimizing the effect of the environment. In this example, the acoustic device 150 can be a piezoelectric sensor. Piezoelectric sensors are acoustic sensors that can be used to detect noise associated with, for example, fluid flow, the passing of valves, and other noise-creating events associated with a flare gas system. These sensors utilize the piezoelectric effect, where certain materials generate an electric charge when subjected to mechanical stress. In the context of valve detection, for example, piezoelectric sensors are typically placed in close proximity to the valve or its housing. When a valve opens or closes, the resulting mechanical vibrations or pressure changes are picked up by the piezoelectric sensor, causing it to generate an electrical signal. The sensitivity and responsiveness of piezoelectric sensors make them well-suited for detecting the passing of valves, enabling precise monitoring and control in a wide range of industries, including automotive, oil and gas, and fluid systems.

However, piezoelectric sensors, like many acoustic devices, are susceptible to error caused by environmental noise (for example, noise not associated with the passing of a valve, circulation of fluid, or other noise effect to be measured), which reduces the accuracy of these sensors. By minimizing the influence of external factors using the passive noise enclosure 110, the acoustic device 150 (such as a piezoelectric sensor) primarily detects the noise 105 (for example, vibrations and pressure changes) directly associated with the circulation of the fluid 101 (or, in other examples, passing of valves) to improve the accuracy and reliability of the measurements by the acoustic device 150.

As shown in FIG. 1, the passive noise enclosure 110 includes a housing 112 that defines a volume 118 into which the acoustic device 150 is placed and resides during measurement of the noise 105. The housing 112, for example, can be constructed using high density materials that possess excellent sound-blocking properties. The housing 112, for instance, can effectively prevent the entry of environmental noise 103 (within an ambient environment 111) into the volume 118 to interfere with or otherwise affect operation of the acoustic device 150. The housing 112, therefore, can operate to shield the acoustic device 150 from unwanted disturbances such as environmental noise 103.

In some examples, an insulation 109 (such as foam, mineral wool, or otherwise) can be inserted into at least a portion of the volume 118. The insulation 109 can, in combination with the housing 112, further minimize or reduce an amount of the environmental noise 103 that reaches the acoustic device 150 through the housing 112 and the volume 118.

The housing 112, in this example, includes an opening 130 into the volume 118, which is bounded by an interior wall structure 116 of the housing 112. An exterior wall structure 114 of the housing 112 provides environmental protection to the volume 118. In some aspects, the housing 112 can be made of a unitary material such as the inner wall structure 116 and the outer wall structure 114 are contiguously formed of the unitary material. In some aspects, the material can be selected to further enhance passive noise reduction of the environmental noise 103 within the volume 118. Examples of such rigid materials include SonoPan, drywall, MDF, and plywood, among others.

In alternative examples, the inner wall structure 116 and outer wall structure 114 can be formed of different materials. For example, a layer or coating can be applied on the housing as either the inner wall structure 116 or outer wall structure 114 (or both). In some aspects, such a layer or coating is the same for the inner wall structure 116 and outer wall structure 114; alternatively, the layer or coating can be different for the inner wall structure 116 and outer wall structure 114. The rigid materials exemplified herein can be used for the inner wall structure 116 or outer wall structure 114 (or both). In some aspects, flexible materials, such as foam, MLV, rockwool, or a fiberglass (or other) insulation can be used as a layer or coating of the inner wall structure 116 or outer wall structure 114 (or both, such as with some rigid core of the housing 112 between the inner wall structure 116 and outer wall structure 114). In some aspects, an applicable material, such as Quiet Glue or Green Glue can be applied a layer or coating of the inner wall structure 116 or outer wall structure 114 (or both, such as applied to some rigid core of the housing 112 between the inner wall structure 116 and outer wall structure 114).

In this example implementation, the housing 112 is coupled to or attaches to the pipeline 102 with one or more magnets 124. In alternative implementations, mechanical fasteners or adhesives can be used to couple or attach the housing 112 to the pipeline 102. In so attaching, the acoustic device 150 is also acoustically coupled (for example, through contact) to the wall 104. In some aspects, as shown, a biasing member 126 (such as a spring) is attached to the acoustic device 150 from the housing 112 (such as from the inner wall structure 116 as shown) to urge the acoustic device 150 into contact with the wall 104 to improve noise sensing and increase a contact area (and reduce an airgap) between the acoustic device 150 and the pipeline 102.

In this example implementation, the passive noise enclosure 110 includes one or more energy storage devices 120 (such as NiMH batteries or otherwise) and a control circuit 122 (such as a printed circuit board or other form of processing unit). In example aspects, the one or more energy storage devices 120 are electrically coupled to the control circuit 122 to provide electrical power thereto. As explained in more detail herein, the control circuit 122 (which can include one or more hardware processors and one or more interconnected memory modules) can output a tuned noise signal 107 that cancels (for example, due to tuned frequency, amplitude, or both) all or part of the environmental noise 103. In some aspects, for instance, the control circuit 122 implements a machine learning or artificial intelligence model to reduce the environmental noise 103 by converting the noise 103 into a spectrogram image, which is then de-noised by a network to remove noise, then back to time the domain to retain the original cleaned signal.

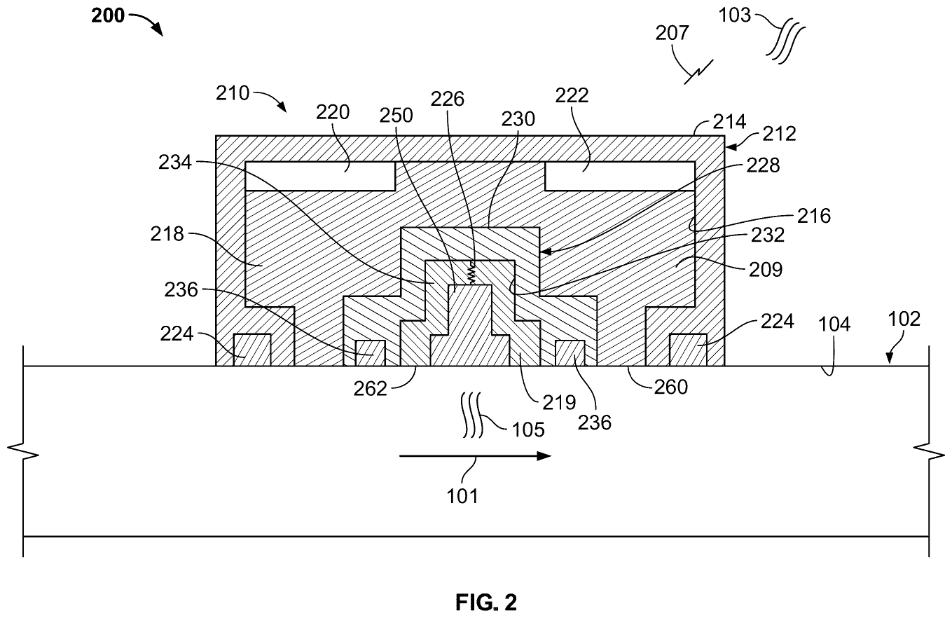

FIG. 2 is a schematic diagram of another example implementation of a passive noise management system 200 according to the present disclosure. The example passive noise management system 200, as shown, includes an inner housing 228 that is coupled to (in other words, detachably engaged with) the pipeline 102 that carries the fluid 101 therethrough. In this example, the acoustic device 150 is enclosed within the inner housing 228 and mounted to (attached or otherwise in contact with) the wall 104 of the pipeline 102 and operable to measure the noise 105. In this example, the inner housing 228 is enclosed within a volume 218 of an outer housing 212. The outer housing 212 is also coupled to (in other words, detachably engaged with) the pipeline 102.

Regarding inner housing 228, the volume 234 at least partially encloses the acoustic device 150 during measurement of the noise 105. The inner housing 228, for example, can be constructed using high density materials that possess excellent sound-blocking properties. The inner housing 228, for instance, can effectively prevent the entry of environmental noise 103 into the volume 234 to interfere with or otherwise affect operation of the acoustic device 150. The inner housing 228, therefore, can operate to shield the acoustic device 150 from unwanted disturbances such as environmental noise 103.

In some examples, an insulation 219 (such as foam, mineral wool, or otherwise) can be inserted into at least a portion of the volume 234. The insulation 219 can, in combination with the inner housing 228, further minimize or reduce an amount of the environmental noise 103 that reaches the acoustic device 150 through the inner housing 228 and the volume 234.

The inner housing 228, in this example, includes an opening 262 into the volume 234, which is bounded by an interior wall structure 232 of the inner housing 228. An exterior wall structure 230 of the inner housing 228 provides environmental protection to the volume 234. In some aspects, the inner housing 228 can be made of a unitary material such as the inner wall structure 232 and the outer wall structure 230 are contiguously formed of the unitary material. In some aspects, the material can be selected to further enhance passive noise reduction of the environmental noise 103 (within or from ambient environment 111) within the volume 234. Examples of such rigid materials include SonoPan, drywall, MDF, and plywood, among others.

In alternative examples, the inner wall structure 232 and outer wall structure 230 can be formed of different materials. For example, a layer or coating can be applied on the housing as either the inner wall structure 232 or outer wall structure 230 (or both). In some aspects, such a layer or coating is the same for the inner wall structure 232 and outer wall structure 230; alternatively, the layer or coating can be different for the inner wall structure 232 and outer wall structure 230. The rigid materials exemplified herein can be used for the inner wall structure 232 or outer wall structure 230 (or both). In some aspects, flexible materials, such as foam, MLV, rockwool, or a fiberglass (or other) insulation can be used as a layer or coating of the inner wall structure 232 or outer wall structure 230 (or both, such as with some rigid core of the inner housing 228 between the inner wall structure 232 and outer wall structure 230). In some aspects, an applicable material, such as Quiet Glue or Green Glue can be applied a layer or coating of the inner wall structure 232 or outer wall structure 230 (or both, such as applied to some rigid core of the inner housing 228 between the inner wall structure 232 and outer wall structure 230).

In this example implementation, the inner housing 228 is coupled to or attaches to the pipeline 102 with one or more magnets 236. In alternative implementations, mechanical fasteners or adhesives can be used to couple or attach the inner housing 228 to the pipeline 102. In so attaching, the acoustic device 150 is also acoustically coupled (for example, through contact) to the wall 104. In some aspects, as shown, a biasing member 226 (such as a spring) is attached to the acoustic device 150 from the inner housing 228 (such as from the inner wall structure 232 as shown) to urge the acoustic device 150 into contact with the wall 104 to improve noise sensing and increase a contact area (and reduce an airgap) between the acoustic device 150 and the pipeline 102.

Outer housing 212 can be constructed similarly to inner housing 228 or can have a different construction. For example, the volume 218 at least partially encloses the inner housing 228 (and thus the acoustic device 150 during measurement of the noise 105). The outer housing 212, for example, can be constructed using high density materials that possess excellent sound-blocking properties. The outer housing 212, for instance, can further prevent the entry of environmental noise 103 into the volume 218 to interfere with or otherwise affect operation of the acoustic device 150. The inner housing 228, therefore, can operate to shield the acoustic device 150 from unwanted disturbances such as environmental noise 103.

In some examples, an insulation 209 (such as foam, mineral wool, or otherwise) can be inserted into at least a portion of the volume 218. The insulation 209 can, in combination with the outer housing 212, further minimize or reduce an amount of the environmental noise 103 that reaches the acoustic device 150 through the outer housing 212 and the volume 218 to the inner housing 228.

The outer housing 212, in this example, includes an opening 260 into the volume 218, which is bounded by an interior wall structure 216 of the outer housing 212. An exterior wall structure 214 of the outer housing 212 provides environmental protection to the volume 234. In some aspects, the outer housing 212 can be made of a unitary material such as the inner wall structure 216 and the outer wall structure 214 are contiguously formed of the unitary material. In some aspects, the material can be selected to further enhance passive noise reduction of the environmental noise 103 within the volume 218. Examples of such rigid materials include SonoPan, drywall, MDF, and plywood, among others.

In alternative examples, the inner wall structure 216 and outer wall structure 214 can be formed of different materials. For example, a layer or coating can be applied on the housing as either the inner wall structure 216 or outer wall structure 214 (or both). In some aspects, such a layer or coating is the same for the inner wall structure 216 and outer wall structure 214; alternatively, the layer or coating can be different for the inner wall structure 216 and outer wall structure 214. The rigid materials exemplified herein can be used for the inner wall structure 216 or outer wall structure 214 (or both). In some aspects, flexible materials, such as foam, MLV, rockwool, or a fiberglass (or other) insulation can be used as a layer or coating of the inner wall structure 216 or outer wall structure 214 (or both, such as with some rigid core of the outer housing 212 between the inner wall structure 216 and outer wall structure 214). In some aspects, an applicable material, such as Quiet Glue or Green Glue can be applied a layer or coating of the inner wall structure 216 or outer wall structure 214 (or both, such as applied to some rigid core of the outer housing 212 between the inner wall structure 216 and outer wall structure 214).

In this example implementation, the outer housing 212 is coupled to or attaches to the pipeline 102 with one or more magnets 224. In alternative implementations, mechanical fasteners or adhesives can be used to couple or attach the outer housing 212 to the pipeline 102.

In this example implementation, one or more energy storage devices 220 (such as NiMH batteries or otherwise) and a control circuit 222 (such as a printed circuit board or other form of processing unit) are mounted in the outer housing 212; alternatively, these components can be mounted within volume 234 of the inner housing 228. In example aspects, the one or more energy storage devices 220 are electrically coupled to the control circuit 222 to provide electrical power thereto. As explained in more detail herein, the control circuit 222 (which can include one or more hardware processors and one or more interconnected memory modules) can output a tuned noise signal 207 that cancels (for example, due to tuned frequency, amplitude, or both) all or part of the environmental noise 103. In some aspects, for instance, the control circuit 222 implements a machine learning or artificial intelligence model to reduce the environmental noise 103 by converting the noise 103 into a spectrogram image, which is then de-noised by a network to remove noise, then back to time the domain to retain the original cleaned signal.

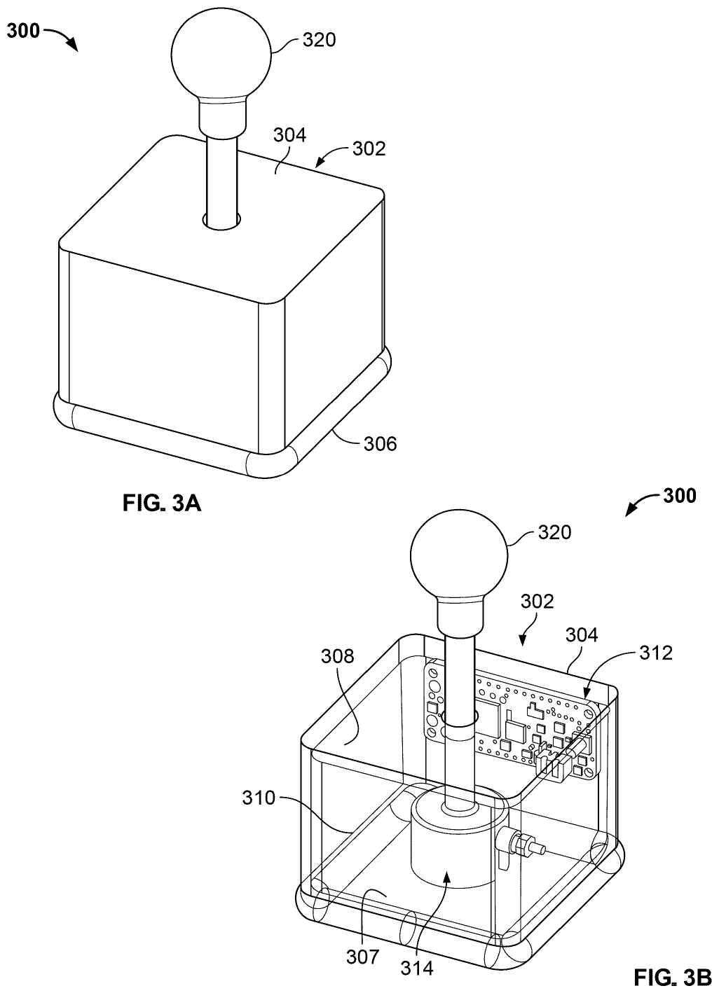

FIGS. 3A and 3B are schematic diagrams of another example implementation of a passive noise management system 300 according to the present disclosure. FIG. 3A shows an exterior view of the passive noise management system 300, while FIG. 3B shows a transparent view into an interior of the passive noise management system 300. The example passive noise management system 300, as shown, includes a casing 302 that can be coupled to (in other words, detachably engaged with) a noise generating object, such as a pipeline or valve or other object to measure or monitor noise signals.

The casing 302 defines a volume 310 that is accessible by an opening 307 and into which an acoustic device 314 (similar to or the same as acoustic device 150) is placed and resides during measurement of noise. The casing 302, in this example, is defined by an outer surface 304 and an inner surface 308; such surfaces 304 and 308 can be constructed as described with reference to the inner and outer wall structures described in FIGS. 1 and 2 (or can be constructed in a different manner). As with the volumes described with reference to FIGS. 1 and 2, the volume 310 can be at least partially filled with an insulation material for noise reducing characteristics. Although the housing 302 (as well as housings described with reference to FIGS. 1 and 2) is shown as substantially cube-shaped, other three-dimensional shapes are contemplated by the present disclosure, such as cylinders, rectangular prisms, and other shaped volumes.

In this example implementation, the housing 302 includes a ring 306. The ring 306, for example, can include magnets, mechanical fasteners, adhesives, or suction devices that can be used to couple or attach the housing 302 to another object, such as a pipeline or valve. In so attaching, the acoustic device 314 is also acoustically coupled (for example, through contact) to the object. As shown in this example, as shown, a handle 320 is attached to the housing 302, and in some aspects, through the housing 302 to the acoustic device 314. The handle 320, can be used to position the housing 302, the acoustic device 314, or both.

In this example implementation, the passive noise management system 300 includes a control board 312 that includes, for example, one or more energy storage devices, one or more hardware processors, one or more interconnected memory modules, and, in some aspects, a communication interface. In some aspects, the control board 312 can output a tuned noise signal that cancels (for example, due to tuned frequency, amplitude, or both) all or part of an environmental noise. In some aspects, for instance, the control board 312 implements a machine learning or artificial intelligence model to reduce the environmental noise by converting the noise into a spectrogram image, which is then de-noised by a network to remove noise, then back to time the domain to retain the original cleaned signal.

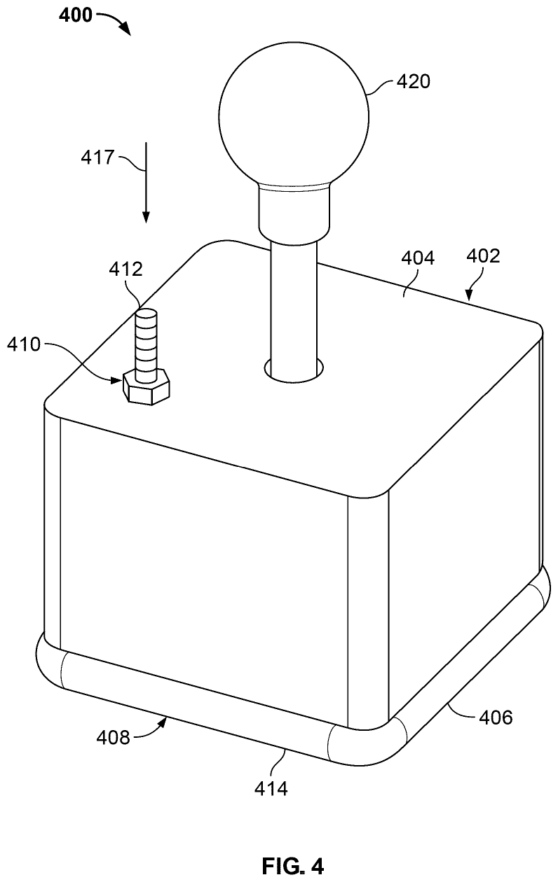

FIG. 4 is a schematic diagram of another example implementation of a passive noise management system 400 according to the present disclosure. The example passive noise management system 400, as shown, includes a casing (or housing) 402 that can be coupled to (in other words, detachably engaged with) a noise generating object, such as a pipeline or valve or other object to measure or monitor noise signals.

The casing 402 defines a volume 408 that is accessible by an opening 414 and into which an acoustic device (similar to or the same as acoustic device 150) is placed and resides during measurement of noise. The casing 402, in this example, is defined by an outer wall 404 and an inner wall (not labeled); such walls can be constructed as described with reference to the inner and outer wall structures described in FIGS. 1 and 2 (or can be constructed in a different manner). As with the volumes described with reference to FIGS. 1 and 2, the volume 408 can be at least partially filled with an insulation material for noise reducing characteristics. Although the housing 402 (as well as housings described with reference to FIGS. 1 and 2) is shown as substantially cube-shaped, other three-dimensional shapes are contemplated by the present disclosure, such as cylinders, rectangular prisms, and other shaped volumes.

In this example implementation, the housing 402 includes a ring 406. The ring 406, for example, can include magnets, mechanical fasteners, adhesives, or suction devices that can be used to couple or attach the housing 402 to another object, such as a pipeline or valve. In so attaching, an acoustic device is also acoustically coupled (for example, through contact) to the object. As shown in this example, as shown, a handle 420 is attached to the housing 402, and in some aspects, through the housing 402 to an acoustic device. The handle 420, can be used to position the housing 402, or an acoustic device, or both. Like the passive noise management system 300, the passive noise management system 400 can include a control board (not shown) that includes, for example, one or more energy storage devices, one or more hardware processors, one or more interconnected memory modules, and, in some aspects, a communication interface.

As shown in FIG. 4, the passive noise management system 400 further includes a port 410 with a nozzle 412 that, when open, fluidly couples the volume 408 with an ambient environment or a fluid source. For example, in some aspects, the nozzle 412 can be opened to pull a vacuum in the volume 408 (such as when the housing 402 is secured to an object such as a pipeline or valve). In some aspects, acoustic waves (such as environmental noise) travel faster through more dense fluids as compared to less dense fluids. Acoustic waves travel faster through liquid than gas; thus, by removing gas (in other words, air), from the volume 408 through port 410 (and open nozzle 412), a vacuum is created by lowering the pressure within the volume 408. The vacuum in the volume 408 can be pulled either by hand manually or using a mechanical pump or electrical pump. A pump can pump out or remove air from the volume 408 in which an acoustic device is installed.

In some aspects, the nozzle 412/port 410 can be or act as a one-way valve that can be closed shut when the vacuum process is finished. An active closed loop system can also be installed such that air pressure within the volume 408 is continuously (or periodically) monitored, and a pump is activated (based on the monitoring) to maintain a vacuum inside the casing 402.

In some aspects, rather than facilitating a vacuum (or at least partial vacuum) in the volume 408, the nozzle 412/port 410 can be used to flow a gas 417 (such as an inert gas like argon or krypton) into the volume 408 when the casing 402 is attached to an object. For example, instead of completely removing air out of the volume 408 (in cases where that might not be possible), the gas 417 or mixture of gasses with a specific density (or mixed density) can be injected into the volume 408 through the nozzle 412 and port 410 to be sealed inside the casing 402. The injected gas 417 or gasses can create a specific reduction in environmental noise that passes through the casing 402 and into the volume 408. In some aspects, whether in the vacuum creation or injection of gas 417, a seal between the casing 402 and an object can be achieved with the ring 406 (such as with a ring of a rubber layer or bellows) to complete the closure of the volume 408 (in other words, fluidly seal opening 414 against the object).

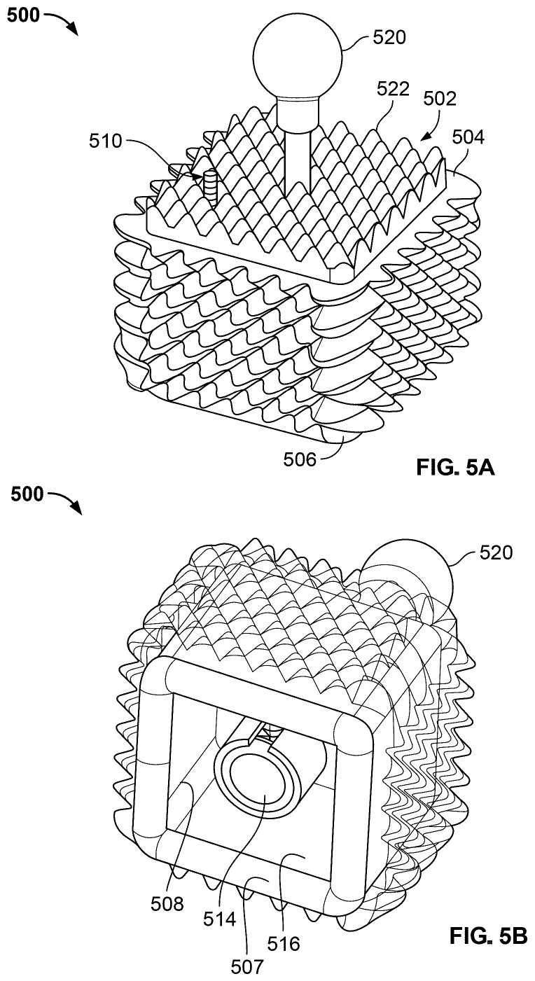

FIGS. 5A and 5B are schematic diagrams of another example implementation of a passive noise management system 500 according to the present disclosure. FIG. 5A shows an exterior view of the passive noise management system 500, while FIG. 5B shows a transparent view into an interior of the passive noise management system 500. The example passive noise management system 500, as shown, includes a casing (or housing) 502 that can be coupled to (in other words, detachably engaged with) a noise generating object, such as a pipeline or valve or other object to measure or monitor noise signals.

The casing 502 defines a volume 516 that is accessible by an opening 507 and into which an acoustic device 514 (similar to or the same as acoustic device 150) is placed and resides during measurement of noise. The casing 502, in this example, is defined by an outer surface 504 and an inner surface 508; such surfaces 504 and 508 can be constructed as described with reference to the inner and outer wall structures described in FIG. 1, 2, or 3A-3B (or can be constructed in a different manner). As with the volumes described with reference to FIG. 1, 2, or 3A-3B, the volume 516 can be at least partially filled with an insulation material for noise reducing characteristics. Although the housing 502 (as well as housings described with reference to FIG. 1, 2, or 3A-3B) is shown as substantially cube-shaped, other three-dimensional shapes are contemplated by the present disclosure, such as cylinders, rectangular prisms, and other shaped volumes.

In this example implementation, the housing 502 includes a ring 506. The ring 506, for example, can include magnets, mechanical fasteners, adhesives, or suction devices that can be used to couple or attach the housing 502 to another object, such as a pipeline or valve. In so attaching, the acoustic device 514 is also acoustically coupled (for example, through contact) to the object. As shown in this example, as shown, a handle 520 is attached to the housing 502, and in some aspects, through the housing 502 to the acoustic device 514. The handle 520, can be used to position the housing 502, the acoustic device 514, or both.

As shown in FIGS. 5A and 5B, the passive noise management system 500 further includes a port/nozzle 510 (similar to the port 410 with a nozzle 412 shown in FIG. 4). In some aspects, when open, the port/nozzle 510 fluidly couples the volume 516 with an ambient environment or a fluid source. For example, in some aspects, the port/nozzle 510 can be opened to pull a vacuum in the volume 516 (such as when the housing 502 is secured to an object such as a pipeline or valve) as described with reference to FIG. 4. Alternatively, rather than facilitating a vacuum (or at least partial vacuum) in the volume 516, the port/nozzle 510 can be used to flow a gas (such as an inert gas) into the volume 516 when the casing 502 is attached to an object (as described with reference to FIG. 4).

In this example implementation, the passive noise management system 500 includes a control board that includes, for example, one or more energy storage devices, one or more hardware processors, one or more interconnected memory modules, and, in some aspects, a communication interface. In some aspects, the control board can output a tuned noise signal that cancels (for example, due to tuned frequency, amplitude, or both) all or part of an environmental noise. In some aspects, for instance, the control board implements a machine learning or artificial intelligence model to reduce the environmental noise by converting the noise into a spectrogram image, which is then de-noised by a network to remove noise, then back to time the domain to retain the original cleaned signal.

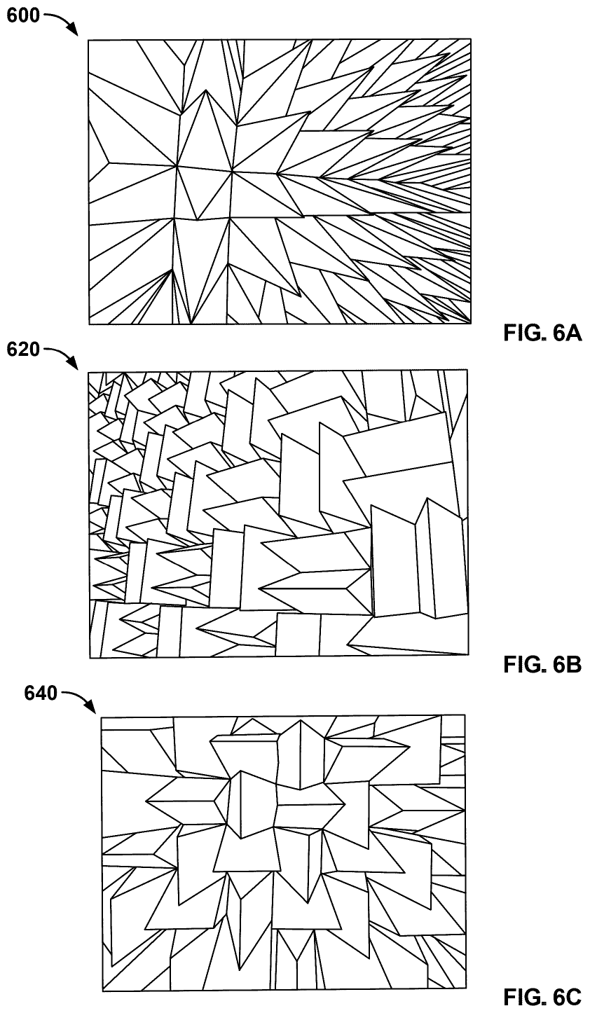

In the example implementation of the passive noise management system 500, an anechoic coating 522 is applied to the outer surface 504 of the housing 502. Turning briefly to FIGS. 6A-6C example sound reduction or cancellation coatings (such as anechoic coatings) for a passive noise management system are shown. More specifically, example anechoic coatings 600, 620, and 640 are shown, which comprise various geometric shaped extensions (such as spikes, ridges, pyramidal shapes, and others). In example aspects, such shaped extensions of the anechoic coatings 600, 620, and 640 can be designed (along with, for example, the material from which the coating is made, such as foam or other material) to attenuate environmental noise and reduce or eliminate such noise from reaching a volume of a passive noise management system.

As shown in FIGS. 5A and 5B, the anechoic coating 522 is applied to the outer surface 504 of the housing 502 (e.g., the five sides of the outer surface 504). Such anechoic coating 522 can absorb external noise from the environment. The anechoic coating 522 can be applied (e.g., fastened or glued) over or on the structure of the outer surface 504, or can form the structure of the outer surface 504 of the housing 502. Although not shown in this example, a similar or other anechoic coating can be applied to inner surface 508 (in addition to the anechoic coating 522 or exclusive of any anechoic coating applied to the outer surface 504).

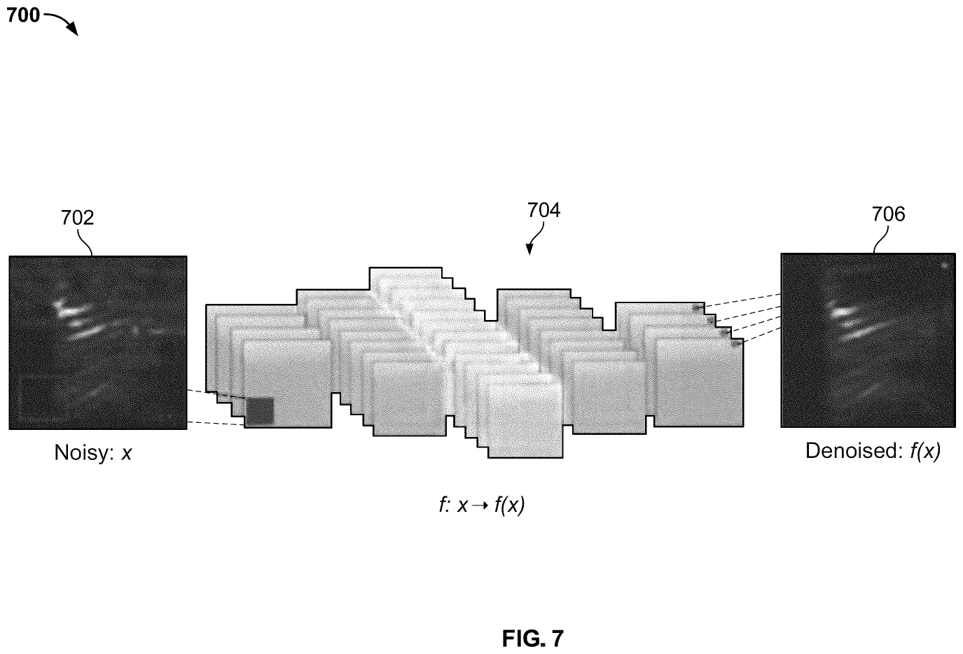

FIG. 7 is a schematic diagram of an example process 700 for using a machine learning or an artificial intelligence model with a passive noise management system to reduce noise in an audio signal according to the present disclosure. Generally, process 700 includes collecting or receiving acoustic data 702 that is considered “noisy,” applying a machine learning or AI model 704 to such acoustic data 702, and outputting denoised acoustic data 706 (free of environmental noise signals) from the model 704. The example process 700 can be implemented, for example, by a controller (circuit board, control circuit, or otherwise) of a passive noise management system.

For example, process 700 can represent an architecture used as an AI-based noise removal model. The architecture can include preprocessing. In preprocessing, the input signal is preprocessed to prepare it for further analysis. This can include resampling, normalization, or feature extraction to convert the signal into a suitable format for the subsequent layers of the model.

The architecture can also include feature extraction. In feature extraction, the model extracts relevant features from the input signal. These features can capture the characteristics and patterns necessary for noise identification and removal. Techniques for feature extraction in audio signals include Fourier transforms, Mel-frequency cepstral coefficients (MFCC), or wavelet transforms.

The architecture can include neural network layers. In example aspects, the model employs deep neural networks to learn and extract meaningful representations of the input signal. This can involve using various types of layers such as convolutional layers, recurrent layers (such as LSTM or GRU), or fully connected layers. The architecture can consist of multiple layers stacked together, allowing the model to learn hierarchical representations of the signal.

The architecture can include noise identification. The model's architecture includes components that are responsible for identifying and distinguishing noise from the desired signal. This can be accomplished through classification layers or by incorporating specific mechanisms that capture the statistical properties of noise.

The architecture can include noise removal. Once the noise is identified, the model applies specific algorithms or layers to remove the noise components from the input signal. This can include adaptive filtering, spectral subtraction, or deep learning-based methods like autoencoders or generative adversarial networks (GANs).

The architecture can include post-processing. In post-processing, after the noise removal stage, the model can employ additional post-processing steps to further refine the output signal. This can include denoising filters, smoothing techniques, or any other relevant signal processing methods to enhance the quality of the final output.

An example architecture that can be used in implementations according to the present disclosure is the U-Net architecture. The U-Net architecture can implement tasks involving image and audio segmentation, including noise removal. In example aspects, the U-Net architecture includes an encoder-decoder structure with skip connections between corresponding layers of the encoder and decoder.

The encoder part of the U-Net architecture includes multiple convolutional layers followed by downsampling operations such as max pooling. Each convolutional layer extracts increasingly higher-level features from the input signal, while downsampling reduces the spatial dimensionality.

Skip connections are added between corresponding layers of the encoder and decoder. These connections preserve the high-resolution features from the encoder and help in the reconstruction of the output signal. They facilitate the flow of information from the early layers (which capture low-level details) to the later layers (which capture high-level semantic information).

The decoder part of the U-Net architecture includes upsampling operations, such as transposed convolutions or bilinear upsampling, followed by convolutional layers. The upsampling operations increase the spatial dimensionality of the features, allowing the model to reconstruct the output signal.

At each upsampling step in the decoder, the features from the corresponding layer in the encoder are concatenated with the upsampled features. This helps in merging the low-level and high-level features, allowing the model to recover fine details while maintaining contextual information.

The final layer of the U-Net architecture is a convolutional layer that produces the denoised output signal. The output layer can have a single channel for mono audio signals or multiple channels for stereo or multi-channel audio.

In some examples, by training the U-Net architecture on a dataset containing pairs of noisy and clean audio signals, the model learns to map the noisy input to the desired clean output. The loss function used during training is typically based on the comparison of the denoised output with the corresponding clean signal.

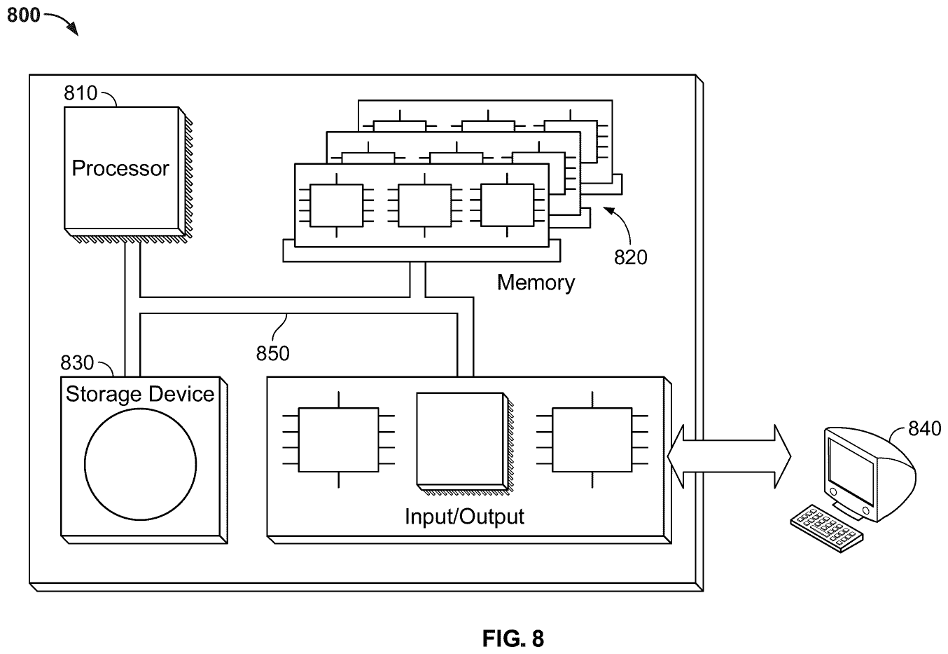

FIG. 8 is a schematic illustration of an example controller (or control system) 800 for a passive noise management system according to the present disclosure. For example, all or a part of the controller 800 may include or be part of a control circuit 122, 222, or 312 shown as part of passive noise management systems 100, 200, and 300 according to the present disclosure. The controller 800 is intended to include various forms of digital computers, such as printed circuit boards (PCB), processors, digital circuitry, or otherwise parts of a passive noise management system. Additionally, the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 800 includes a processor 810, a memory 820, a storage device 830, and an input/output device 840. Each of the components 810, 820, 830, and 840 are interconnected using a system bus 850. The processor 810 is capable of processing instructions for execution within the controller 800. The processor may be designed using any of a number of architectures. For example, the processor 810 may be a CISC (Complex Instruction Set Computers) processor, a RISC (Reduced Instruction Set Computer) processor, or a MISC (Minimal Instruction Set Computer) processor.

In one implementation, the processor 810 is a single-threaded processor. In another implementation, the processor 810 is a multi-threaded processor. The processor 810 is capable of processing instructions stored in the memory 820 or on the storage device 830 to display graphical information for a user interface on the input/output device 840.

The memory 820 stores information within the controller 800. In one implementation, the memory 820 is a computer-readable medium. In one implementation, the memory 820 is a volatile memory unit. In another implementation, the memory 820 is a non-volatile memory unit.

The storage device 830 is capable of providing mass storage for the controller 800. In one implementation, the storage device 830 is a computer-readable medium. In various different implementations, the storage device 830 may be a floppy disk device, a hard disk device, an optical disk device, or a tape device.

The input/output device 840 provides input/output operations for the controller 800. In one implementation, the input/output device 840 includes a keyboard and/or pointing device. In another implementation, the input/output device 840 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, for example, in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random-access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer. Additionally, such activities can be implemented via touchscreen flat panel displays and other appropriate mechanisms.

The features can be implemented in a control system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

What is claimed is:

1. A passive noise management system, comprising:
a housing that comprises:
a volume defined by an outer surface and an inner surface; and
an opening in the housing configured to access the volume, the volume configured to at least partially enclose an acoustic device configured to measure acoustic energy generated by an object, the housing configured to couple to the object to form an enclosure around the acoustic device that is fluidly decoupled from an ambient environment, the enclosure comprising the housing and at least a portion of the object; and
at least one sound reducer coupled to the housing or enclosed within the volume, the at least one sound reducer configured to reduce an amount of environmental noise transferred from the ambient environment, through the housing, and to the acoustic device.

2. The passive noise management system of claim 1, wherein the at least one sound reducer comprises an insulation enclosed within the volume.

3. The passive noise management system of claim 1, wherein the at least one sound reducer comprises a sound reduction coating or sound reduction layer coupled to at least one of the outer surface or the inner surface.

4. The passive noise management system of claim 3, wherein the at least one sound reducer comprises a sound reduction coating or sound reduction layer coupled to the outer surface and the inner surface.

5. The passive noise management system of claim 3, wherein the sound reduction coating or sound reduction layer comprises an anechoic coating or layer.

6. The passive noise management system of claim 3, wherein the sound reduction coating or sound reduction layer comprises at least one of a SonoPan layer, a drywall layer, an MDF layer, or a plywood layer.

7. The passive noise management system of claim 1, wherein the housing is a first housing, the system comprising:
a second housing that comprises:
a second volume defined by a second outer surface and a second inner surface; and
a second opening in the second housing configured to access the first housing and the acoustic device, the second volume configured to at least partially enclose the first housing, the second housing configured to couple to the object to form a second enclosure around the first acoustic device that is fluidly decoupled from the ambient environment, the second enclosure comprising the second housing and at least another portion of the object.

8. The passive noise management system of claim 1, wherein the acoustic device is attached to the inner surface with a biasing member configured to urge the acoustic device into contact with the object.

9. The passive noise management system of claim 1, comprising one or more magnets configured to detachably secure the housing to the object.

10. The passive noise management system of claim 1, comprising a port positioned on the housing and configured, when open, to fluidly couple the volume to the ambient environment and further configured, when closed, to fluidly isolate the volume from the ambient environment.

11. The passive noise management system of claim 10, wherein the at least one sound reducer comprises a fluid circulated into the volume through the port when opened.

12. The passive noise management system of claim 10, wherein the at least one sound reducer comprises a vacuum pulled in the volume by exhausting at least a portion of air from the volume to the ambient environment through the port when opened.

13. The passive noise management system of claim 1, comprising a control circuit positioned in the volume, the control circuit configured to output a noise signal that cancels at least a portion of the environmental noise.

14. The passive noise management system of claim 13, wherein the control circuit executes a machine learning or artificial intelligence model to output the noise signal that cancels the portion of the environmental noise.

15. The passive noise management system of claim 1, wherein the object comprises a pipeline.

16. A method, comprising:
positioning an acoustic device in a housing of a passive noise management system;
coupling the housing to an object to form an enclosure around the acoustic device that is fluidly decoupled from an ambient environment, the housing comprising:
a volume defined by an outer surface and an inner surface; and
an opening in the housing configured to access the volume, the volume configured to at least partially enclose; and
subsequent to coupling the housing to the object, measuring acoustic energy generated by the object with the acoustic device; and
during measuring, reducing an amount of environmental noise transferred from the ambient environment, through the housing, and to the acoustic device with at least one sound reducer coupled to the housing or enclosed within the volume.

17. The method of claim 16, comprising reducing the amount of environmental noise transferred from the ambient environment, through the housing, and to the acoustic device with the at least one sound reducer that comprises an insulation enclosed within the volume.

18. The method of claim 16, comprising reducing the amount of environmental noise transferred from the ambient environment, through the housing, and to the acoustic device with the at least one sound reducer that comprises a sound reduction coating or sound reduction layer coupled to at least one of the outer surface or the inner surface.

19. The method of claim 18, comprising reducing the amount of environmental noise transferred from the ambient environment, through the housing, and to the acoustic device with the at least one sound reducer that comprises a sound reduction coating or sound reduction layer coupled to the outer surface and the inner surface.

20. The method of claim 18, wherein the sound reduction coating or sound reduction layer comprises an anechoic coating or layer.

21. The method of claim 18, wherein the sound reduction coating or sound reduction layer comprises at least one of a SonoPan layer, a drywall layer, an MDF layer, or a plywood layer.

22. The method of claim 16, wherein the housing is a first housing, the method comprising:
at least partially enclosing the first housing in a second housing of the passive noise management system, the second housing comprising:
a second volume defined by a second outer surface and a second inner surface; and
a second opening in the second housing configured to access the first housing and the acoustic device, the second volume configured to at least partially enclose the first housing, the second housing configured to couple to the object to form a second enclosure around the first acoustic device that is fluidly decoupled from the ambient environment, the second enclosure comprising the second housing and at least another portion of the object.

23. The method of claim 16, comprising urging the acoustic device into contact with the object with a biasing member that attaches the acoustic device to the inner surface.

24. The method of claim 16, wherein coupling the housing to the object comprises detachably securing the housing to the object with one or more magnets.

25. The method of claim 16, comprising operating a port positioned on the housing to:
open the port to fluidly couple the volume to the ambient environment; or
close the port to fluidly isolate the volume from the ambient environment.

26. The method of claim 25, comprising:
operating the port to open the port;
circulating a fluid through the opened port into the volume;
operating the port to close the port to enclose the circulated fluid in the volume; and
reducing the amount of environmental noise transferred from the ambient environment, through the housing, and to the acoustic device with the fluid in the volume.

27. The method of claim 25, comprising:
operating the port to open the port;
circulating a fluid through the opened port from the volume into the ambient environment;
operating the port to close the port to create at least a partial vacuum in the volume; and
reducing the amount of environmental noise transferred from the ambient environment, through the housing, and to the acoustic device with the at least partial vacuum.

28. The method of claim 16, comprising:
generating, with a control circuit a noise signal; and
canceling at least a portion of the environmental noise with the generated noise signal.

29. The method of claim 28, comprising executing, with the control circuit, a machine learning or artificial intelligence model to generate the noise signal.

30. The method of claim 16, wherein the object comprises a pipeline.
